(19) United States
(12) Patent Application Publication
(10) Pub. No.: US 2013/0121172 A1
(43) Pub. Date: May 16, 2013

(54) POWER SAVINGS BASED WIRELESS TRAFFIC CONTROLLER FOR MOBILE DEVICES

(71) Applicants: Steven D. Cheng, San Diego, CA (US); Fangqi Hu, San Diego, CA (US); Ta-yan Siu, San Diego, CA (US); Patrick Lim, San Diego, CA (US); Tom Chin, San Diego, CA (US)

(72) Inventors: Steven D. Cheng, San Diego, CA (US); Fangqi Hu, San Diego, CA (US); Ta-yan Siu, San Diego, CA (US); Patrick Lim, San Diego, CA (US); Tom Chin, San Diego, CA (US)

(73) Assignee: QUALCOMM Incorporated, San Diego, CA (US)

(21) Appl. No.: 13/296,553

(22) Filed: Nov. 15, 2011

(51) Int. Cl. H04W 52/02; H04L 12/26; H04W 24/00; G08C 17/00

(52) U.S. Cl. 370/252; 370/311

(57) ABSTRACT

Aspects of the present disclosure provide methods for power saving at a mobile station by a software module. A software module, residing between an application subsystem and a modem of a mobile station, may buffer uplink data to create power savings in an efficient and dynamic manner. During power saving, the software module may buffer data during modem unavailable intervals and may transmit the buffered data during the modem available intervals.

### BACKGROUND

1. Field

Certain aspects of the present disclosure generally relate to wireless communications and, more particularly, allowing power savings at a mobile device via a software module.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is LTE. LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

Orthogonal frequency-division multiplexing (OFDM) and orthogonal frequency division multiple access (OFDMA) wireless communication systems under IEEE 802.16 use a network of base stations to communicate with wireless devices (i.e., mobile stations) registered for services in the systems based on the orthogonality of frequencies of multiple subcarriers and can be implemented to achieve a number of technical advantages for wideband wireless communications, such as resistance to multipath fading and interference. Each base station (BS) emits and receives radio frequency (RF) signals that convey data to and from the mobile stations. For various reasons, such as a mobile station (MS) moving away from the area covered by one base station and entering the area covered by another, a handover (also known as a handoff) may be performed to transfer communication services (e.g., an ongoing call or data session) from one base station to another.

### SUMMARY

In an aspect of the disclosure, a method for wireless communication is provided. The method generally includes causing a mobile station to enter a low power state in response to observing an uplink data transfer rate between an application subsystem of the mobile station and a base station has fallen below a first threshold, buffering uplink data from the application subsystem to a modem during an unavailable interval of the low power state, and transmitting the buffered uplink data to the modem after the modem exits the unavailable interval of the low power state.

In an aspect of the disclosure, an apparatus for wireless communication is provided. The apparatus generally includes means for means for causing a mobile station to enter a low power state in response to observing an uplink data transfer rate between an application subsystem of the mobile station and a base station has fallen below a first threshold, means for buffering uplink data from the application subsystem to a modem during an unavailable interval of the low power state, and means for transmitting the buffered uplink data to the modem after the modem exits the unavailable interval of the low power state.

In an aspect of the disclosure, an apparatus for wireless communication is provided. The apparatus generally includes at least one processor and a memory coupled to the at least one processor. The at least one processor is generally configured to cause a mobile station to enter a low power state in response to observing an uplink data transfer rate between an application subsystem of the mobile station and a base station has fallen below a first threshold, buffer uplink data from the application subsystem to a modem during an unavailable interval of the low power state, and transmit the buffered uplink data to the modem after the modem exits the unavailable interval of the low power state.

In an aspect of the disclosure, a computer-program product for wireless communication is provided. The computer-program product generally includes a non-transitory computer-readable medium having code stored thereon. The code is generally executable by one or more processors for causing a mobile station to enter a low power state in response to observing an uplink data transfer rate between an application subsystem of the mobile station and a base station has fallen below a first threshold, buffering uplink data from the application subsystem to a modem during an unavailable interval of the low power state, and transmitting the buffered uplink data to the modem after the modem exits the unavailable interval of the low power state.

In an aspect of the disclosure, a method for wireless communication is provided. The method generally includes deriving a mean latency for a service flow, deriving a variance of latency for the service flow, determining one or more mandatory quality of service (QoS) parameters for the service flow, and identifying a sleep opportunity based on the mean latency, the variance of latency, and the one or more mandatory QoS parameters for the service flow.

In an aspect of the disclosure, an apparatus for wireless communication is provided. The apparatus generally includes means for deriving a mean latency for a service flow, means for deriving a variance of latency for the service flow, means for determining one or more mandatory quality of service (QoS) parameters for the service flow, and means for identifying a sleep opportunity based on the mean latency, the variance of latency, and the one or more mandatory QoS parameters for the service flow.

In an aspect of the disclosure, an apparatus for wireless communication is provided. The apparatus generally includes at least one processor and a memory coupled to the at least one processor. The at least one processor is generally configured to derive a mean latency for a service flow, derive a variance of latency for the service flow, determine one or more mandatory quality of service (QoS) parameters for the service flow, and identify a sleep opportunity based on the mean latency, the variance of latency, and the one or more mandatory QoS parameters for the service flow.

In an aspect of the disclosure, a computer-program product for wireless communication is provided. The computer-program product generally includes a non-transitory computer-readable medium having code stored thereon. The code is generally executable by one or more processors for deriving a mean latency for a service flow, deriving a variance of latency for the service flow, determining one or more mandatory quality of service (QoS) parameters for the service flow, and identifying a sleep opportunity based on the mean latency, the variance of latency, and the one or more mandatory QoS parameters for the service flow.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain aspects of the present disclosure.

FIG. 2 illustrates various components that may be utilized in a wireless device, in accordance with certain aspects of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology, in accordance with certain aspects of the present disclosure.

FIG. 4 illustrates an example mobile station and base station, in accordance with certain aspects of the present disclosure.

FIG. 5 illustrates an example call flow diagram, setting up a mobile station available and unavailable interval, in accordance with certain aspects of the present disclosure.

FIG. 6 illustrates an example call flow diagram, where a software module buffers data during a mobile station unavailable interval, in accordance with certain aspects of the present disclosure.

FIG. 7 illustrates an example call flow diagram, where a software module readjusts an available and unavailable interval, in accordance with certain aspects of the present disclosure.

FIG. 8 illustrates an example call flow diagram, where a software module extends a power saving duration, in accordance with certain aspects of the present disclosure.

FIG. 9 illustrates an example call flow diagram, where a software module synchronizes power savings between an application subsystem and modem, in accordance with certain aspects of the present disclosure.

FIG. 10 illustrates an example call flow diagram, where a software module observes a base station-initiated exit from a power saving mode, in accordance with certain aspects of the present disclosure.

FIG. 11 illustrates example operations performed, for example, by a mobile station, in accordance with certain aspects of the present disclosure.

FIG. 12 illustrates the relationship between jitter and maximum latency to the probability density function of latency, in accordance with certain aspects of the present disclosure.

FIG. 13 illustrates a quality of service parameter violation, in accordance with certain aspects of the present disclosure.

FIG. 14 illustrates a quality of service parameter within an acceptable rage, in accordance with certain aspects of the present disclosure.

FIG. 15 illustrates example operations which may be performed, for example by a device in a wireless communication system, in accordance with certain aspects of the present disclosure.

### DETAILED DESCRIPTION

Certain aspects of the present disclosure provide methods for power saving at a mobile station by a software module. According to aspects, a software module, residing between an application subsystem and a modem, may regulate uplink data to create power savings in an efficient and dynamic manner. During power saving, the software module may buffer data during modem unavailable intervals and may transmit the buffered data to the modem during modem available intervals.

### An Example Wireless Communication System

The methods and apparatus of the present disclosure may be utilized in a broadband wireless communication system. The term “broadband wireless” refers to technology that provides wireless, voice, Internet, and/or data network access over a given area.

WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

Mobile WiMAX is based on OFDM (orthogonal frequency-division multiplexing) and OFDMA (orthogonal frequency division multiple access) technology. OFDM is a digital multi-carrier modulation technique that has recently found wide adoption in a variety of high-data-rate communication systems. With OFDM, a transmit bit stream is divided into multiple lower-rate substreams. Each substream is modulated with one of multiple orthogonal subcarriers and sent over one of a plurality of parallel subchannels. OFDMA is a multiple access technique in which users are assigned subcarriers in different time slots. OFDMA is a flexible multiple-access technique that can accommodate many users with widely varying applications, data rates, and quality of service requirements.

The rapid growth in wireless internets and communications has led to an increasing demand for high data rate in the field of wireless communications services. OFDM/OFDMA systems are today regarded as one of the most promising research areas and as a key technology for the next generation of wireless communications. This is due to the fact that OFDM/OFDMA modulation schemes can provide many advantages such as modulation efficiency, spectrum efficiency, flexibility, and strong multipath immunity over conventional single carrier modulation schemes.

IEEE 802.16x is an emerging standard organization to define an air interface for fixed and mobile broadband wireless access (BWA) systems. IEEE 802.16x approved “IEEE P802.16-REVd/D5-2004” in May 2004 for fixed BWA systems and published “IEEE P802.16e/D12 Oct. 2005” in October 2005 for mobile BWA systems. Those two standards defined four different physical layers (PHYs) and one media access control (MAC) layer. The OFDM and OFDMA physical layer of the four physical layers are the most popular in the fixed and mobile BWA areas respectively.

As those skilled in the art will readily appreciate from the detailed description to follow, the various concepts presented herein are well suited for WiMAX applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), LTE, IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

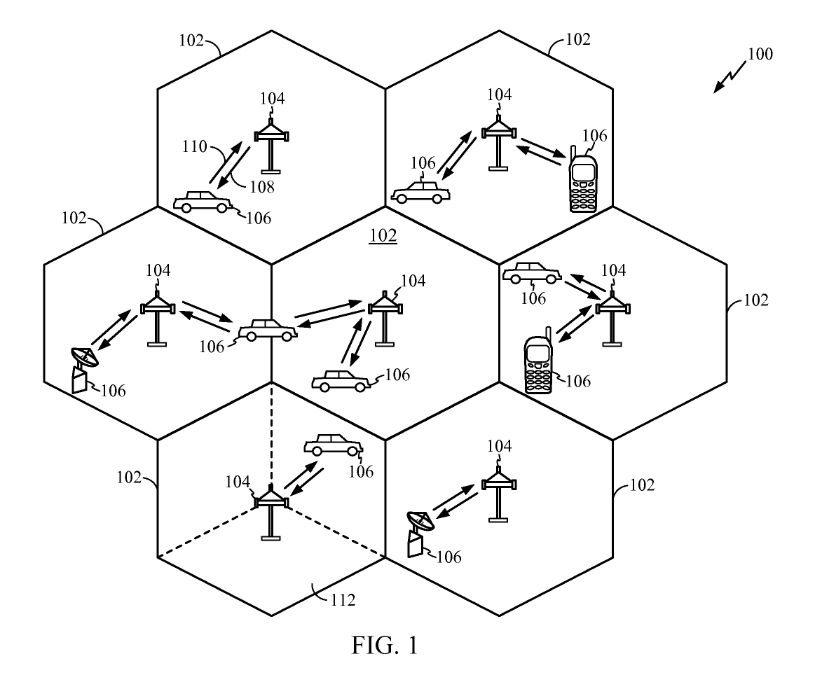

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

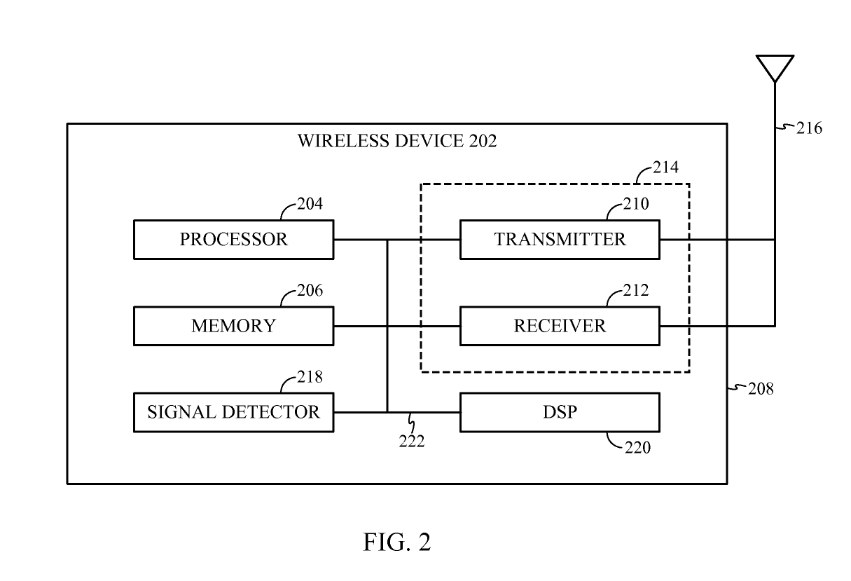

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

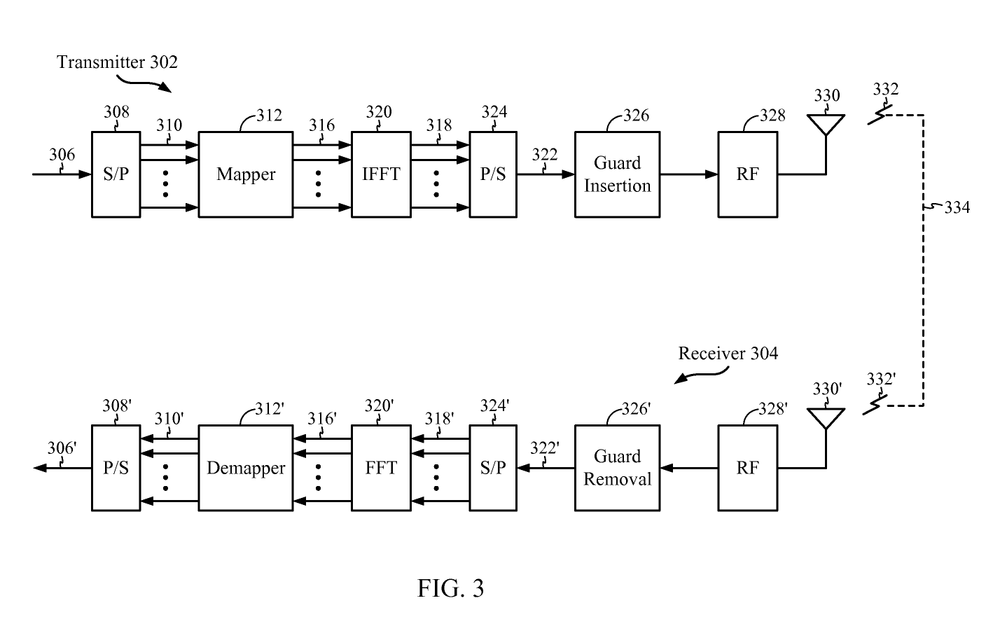

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Power Saving Based Wireless Traffic Controller

In some cases, sleep mode features introduced by WiMAX may not be able to efficiently handle both a low data rate scenario and a burst data rate scenario. For example, a low data rate may cause a mobile station (MS) to transit from a sleep mode unavailable interval to a normal operational mode. A burst data rate may cause a MS to transit from a sleep mode available interval to the normal operational mode which may limit potential power savings.

Further, current designs may lack power saving synchronization between an application subsystem and a modem of a MS. For example, an application may unnecessarily transmit data in a manner that prevents the MS from entering (or maintaining) a low power state.

According to aspects of the present disclosure, a management (e.g., software) module may create power saving opportunities in an efficient and dynamic way. The software module, referred to herein as an Intelligent Wireless Traffic Controller (IWTC), may reside between an application subsystem and modem of a MS. Based on the quality of service (QoS) of uplink and downlink connections and the current data rate, the IWTC may address the issues created during low data rate and burst data rate scenarios and may create power saving opportunities at the MS.

WiMAX provides for four different QoS classes: Unsolicited Grant Service (UGS), Real Time-Variable Rate Service (rtPS), Non-Real Time-Variable Rate Service (nRTPS), and Best Efforts Service (BE). rtPS, nRTPS, and BE use a maximum sustained traffic rate ranging from no requirement, 1,200 (bits/s), . . . , to 1,921,000 (bits/s). UGS, rtPS, and nRTPS use a minimum reserved traffic rate ranging from no requirement, 1,200 (bits/s), . . . , to 1,921,000 (bits/s). UGS and rtPS use a maximum latency ranging from no requirement, 1 ms, . . . , to 10,000 ms. UGS further uses a tolerated jitter and unsolicited grant interval. Tolerated jitter ranges from no requirement, 1 ms, . . . , to 10,000 ms and unsolicited grant interval ranges from 1 frame to 200 frames. rtPS uses an unsolicited polling interval ranging from 1 frame to 200 frames.

For uplink traffic, the network may guarantee the maximum sustained traffic rate requirement for rtPS, nRTPS, and BE, the minimum reserved traffic rate requirement for UGS, rtPS, and nRTPS, and the maximum latency requirement for UGS and rtPS.

For example, in a time period T, one may assume the average maximum sustained traffic rate is v(max), the average minimum reserved traffic rate is v(min), and the average incoming data rate is v(in). Case 1, where v(in)=0, may correspond to a no incoming data scenario in time period T. Case 2, where v(in)<v(min), may correspond to a scenario where the MS may transmit the incoming data in a smaller duration than time period T. Case 3, where v(min)≦v(in)≦v(max), may correspond to a scenario where the MS may be able to transmit data at the same rate as the incoming data. Sometimes, in Case 3, the MS may have to store a portion of data locally in the duration of time period T because the incoming data rate is larger than the transmission rate. This result may not be predicted by the MS, because the data transmission rate is decided by the BS. Case 4, where v(min)<v(max)<v(in), may correspond to a scenario where the MS always has to store a portion of data buffered locally in the time period T. The IWTC may identify that power saving opportunities exist in Case 1 and Case 2, and sometimes in Case 3.

As will be described in more detail below, during a normal operational mode, the IWTC may analyze the QoS parameters associated with uplink and downlink data connections and a current data rate. Based on this information, the IWTC may decide whether it is time to transit the modem layer to sleep mode or not. Additionally, the IWTC may decide the length of available and unavailable intervals.

To increase power savings at the MS, the IWTC may buffer uplink data received, for example from an application subsystem, during unavailable intervals of the modem. The IWTC may transmit the data to the modem during available intervals. By buffering uplink data, the IWTC may allow a modem to remain in a power saving mode during low data rate and burst data rate scenarios. According to aspects, the IWTC may also create power saving opportunities by synchronizing power saving operations between the application subsystem and the modem through, for example, related software dormancy scenarios.

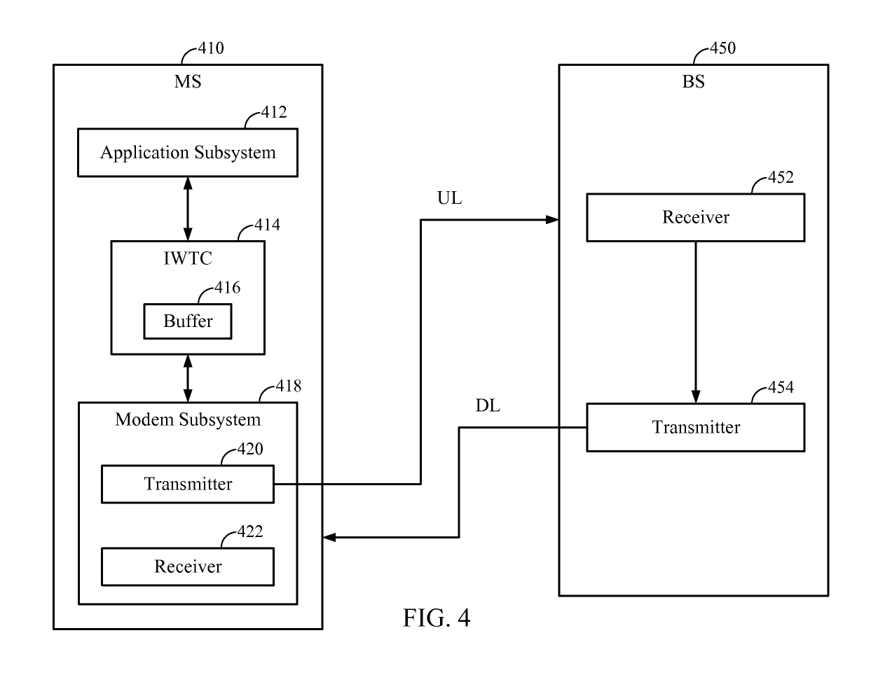

FIG. 4 illustrates an example MS 410 and BS 450, in accordance with aspects of the present disclosure. As will be described in more detail below, an IWTC 414 may reside between an application subsystem 412 and modem subsystem 418 of MS 410. IWTC 414 may have one or more buffers 416 for storing uplink data from the application subsystem 412. According to aspects, the IWTC 414 may buffer data to create power saving opportunities, for example, during low data rate and burst data rate scenarios. A transmitter module 420 may transmit uplink data to a receiver module 452 of BS 450. The transmitter module 454 of BS 450 may transmit downlink data to the receiver 422 of MS 410.

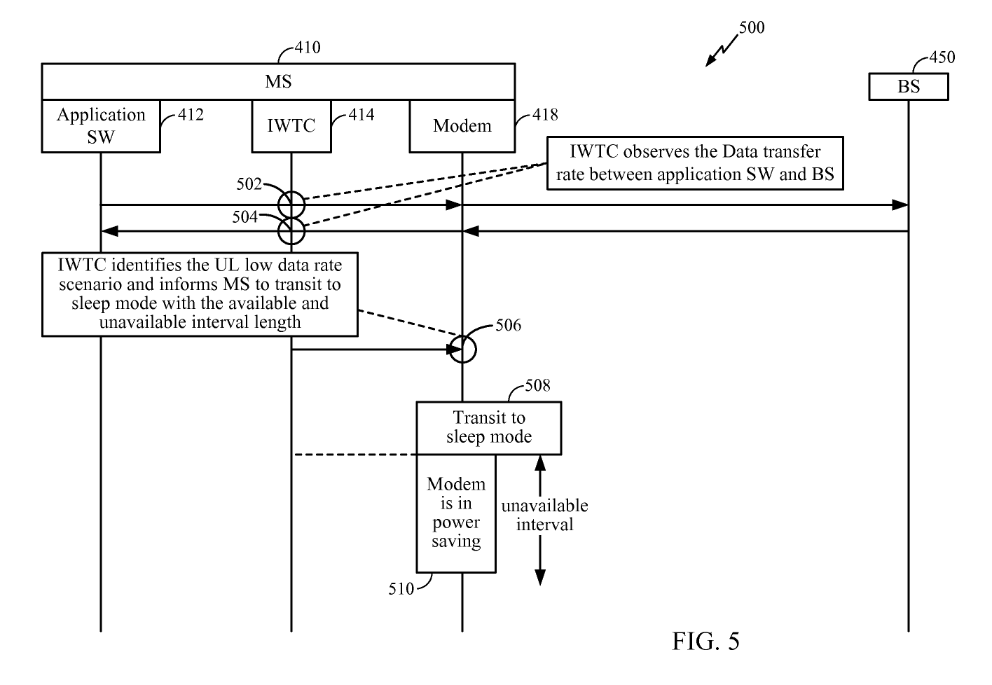

FIG. 5 illustrates an example call flow diagram 500 for determining an available and unavailable interval of a modem 418, in accordance with aspects of the present disclosure. During the normal operational mode, the IWTC 414 of MS 410 may observe uplink traffic 502 from MS 410 and downlink traffic 504 from BS 450 to identify potential power saving opportunities. By analyzing data rates in uplink and downlink connections and associated QoS parameters, the IWTC 414 may decide whether to transit to the modem 418 to a sleep mode or not.

The IWTC 414 may identify a power saving opportunity when it observes a low data rate scenario. For example, at 506, the IWTC 414 may observe that an uplink data rate has fallen below a first threshold and may inform the modem 418 to transit to a power saving sleep mode with an available and unavailable interval decided base on the observed uplink and downlink traffic and assuming that MS 410 is not transmitting to the BS 450. At 508, the modem 418 may transit to a power saving sleep mode. At 510, the modem 418 may be in power saving mode with an unavailable interval as determined by the IWTC 414. As is commonly known, different connections may have different listening and sleep windows. During an unavailable interval, all of the connections may be in a sleep mode.

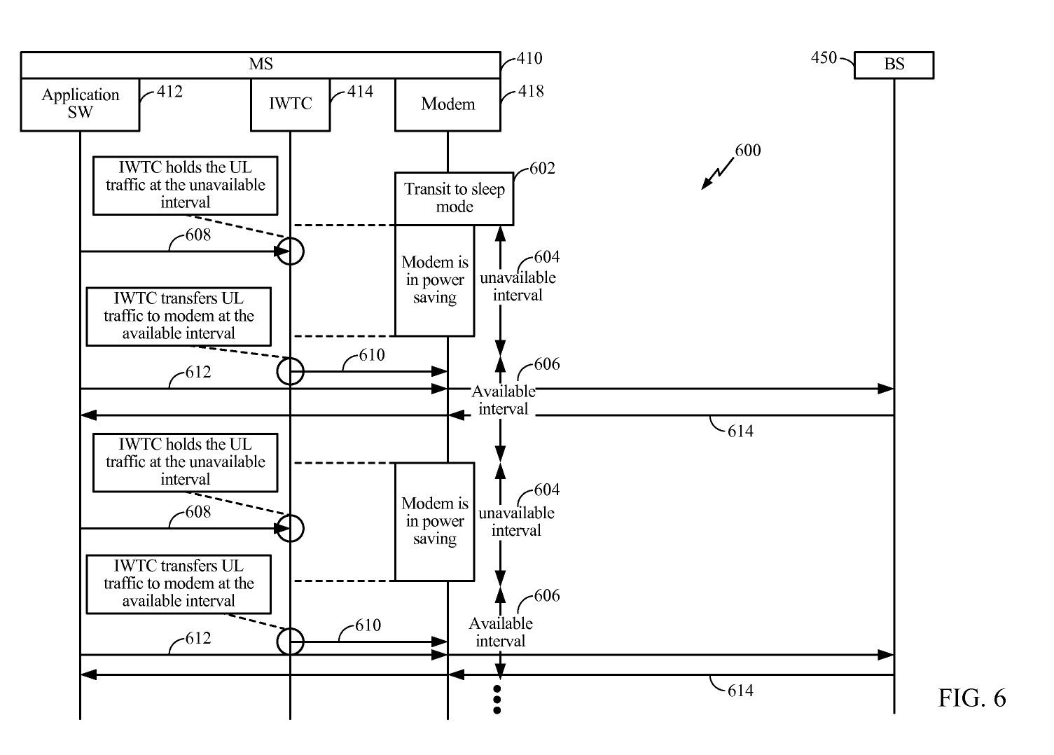

FIG. 6 illustrates an example call flow diagram 600 where the IWTC 414 allows power saving at MS 410 by buffering data during modem unavailable intervals, in accordance with aspects of the present disclosure. At 602, the modem 418 may transit to a sleep mode with unavailable intervals 604 and available intervals 606 determined by the IWTC 414 as described above with reference to FIG. 5. Once the modem 418 is in the sleep mode, the IWTC 414 may begin to regulate uplink traffic from the application subsystem 412.

At 608, the IWTC 414 may buffer uplink traffic from the application subsystem 412 during a modem unavailable interval 604. By buffering uplink data from the application subsystem 412, the IWTC 414 allows the MS 410 to extend power saving by preventing the modem 418 from returning to a normal operating mode from the sleep mode unavailable interval during a low data rate scenario.

Using this configuration, as long as the IWTC 414 is able to buffer incoming data from the application subsystem 412, the MS 410 uses a power saving mode to turn the modem hardware off. The IWTC 414 may transmit the buffered uplink data during paging cycles when the modem wakes up. Paging cycles may be decided by the uplink data rate from the application subsystem 412 and the total buffered data size. According to aspects, the MS 410 may reset the paging cycles if either of these parameters changes.

At 610, the IWTC 414 may transfer buffered uplink traffic to the modem during an available interval 606 of the power saving mode. During the available interval 606, the BS 450 and MS 410 may transmit and receive data, as shown at 612 and 614.

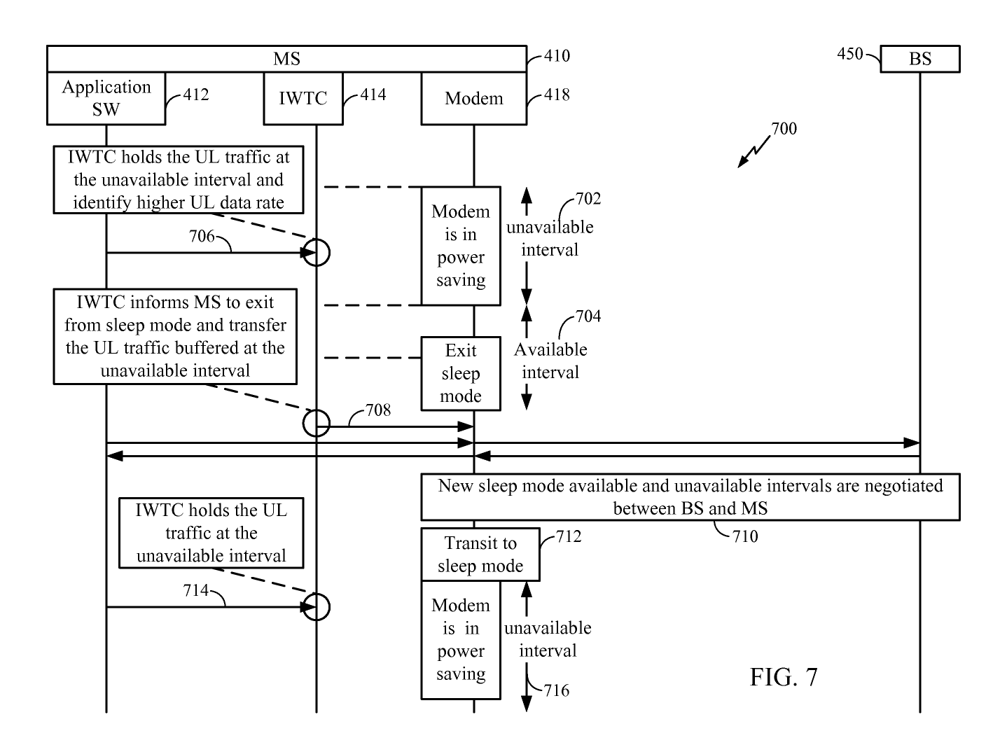

FIG. 7 illustrates an example call flow diagram 700 adjusting one or more intervals of the power saving mode, according to aspects of the present disclosure. As illustrated, one or more intervals of the power saving mode may be adjusted in response to, for example, the IWTC 414 observing a higher uplink data rate.

At 706, the IWTC 414 buffers uplink traffic from the application subsystem 412 and identifies a higher uplink data rate during a power saving unavailable interval 702. At 708, the IWTC 414 may inform the modem 418 to exit from the sleep mode and may transfer buffered uplink data to the modem 418.

At 710, MS 410 and BS 450 may adjust one or more intervals associated with the sleep mode. For example, the MS 410 and BS 450 may negotiate new sleep mode available and unavailable intervals. According to aspects, the new sleep mode available and unavailable interval may be based on, for example, the observed uplink data rate during the unavailable interval 702 as well as the state of one or more applications of the application subsystem.

According to aspects, an application, such as an instant messaging application may have a “standby” state and a “texting” state. The IWTC 414 may alter the QoS of one or more connections maintained by the modem 418 based on the state the application. For example, the IWTC 414 may change the QoS according to the determined state in an effort to achieve increased power savings or best performance at the MS. In order to set up a proper QoS, without this feature, the application subsystem 412 may need to know quite a bit of information regarding characteristics of each RAT, which may not be uniformly defined.

At 710, in addition to negotiating new sleep mode available and unavailable intervals, the IWTC 414 may direct the modem 418 to change its central processing unit (CPU) clock rate. For example, the CPU clock rate may be increased or decreased based on throughput requirements in an effort to achieve efficient power consumption.

At 712, the modem 418 may transit to a sleep mode using the re-negotiated sleep mode available and unavailable intervals. The IWTC 414, at 714, may buffer uplink data during the sleep mode unavailable interval 716, which may be different than sleep mode unavailable interval 702.

Without the IWTC 414 buffering uplink data, as illustrated in the current standard, the modem 418 may be forced to transit back to the normal operation mode immediately when the data appears during the unavailable interval 702 or when the data may not be completely transmitted during the available interval 704. Additionally, without this feature, the modem 418 may be forced back to the normal operation mode when the uplink data rate drops to an even lower value, such that some of the frames of the available interval will be idle.

During the sleep mode available and unavailable interval readjustment process, the MS 410 may transit back to the normal operational mode, if, for example, the related signaling procedure may not be completed within the same available interval.

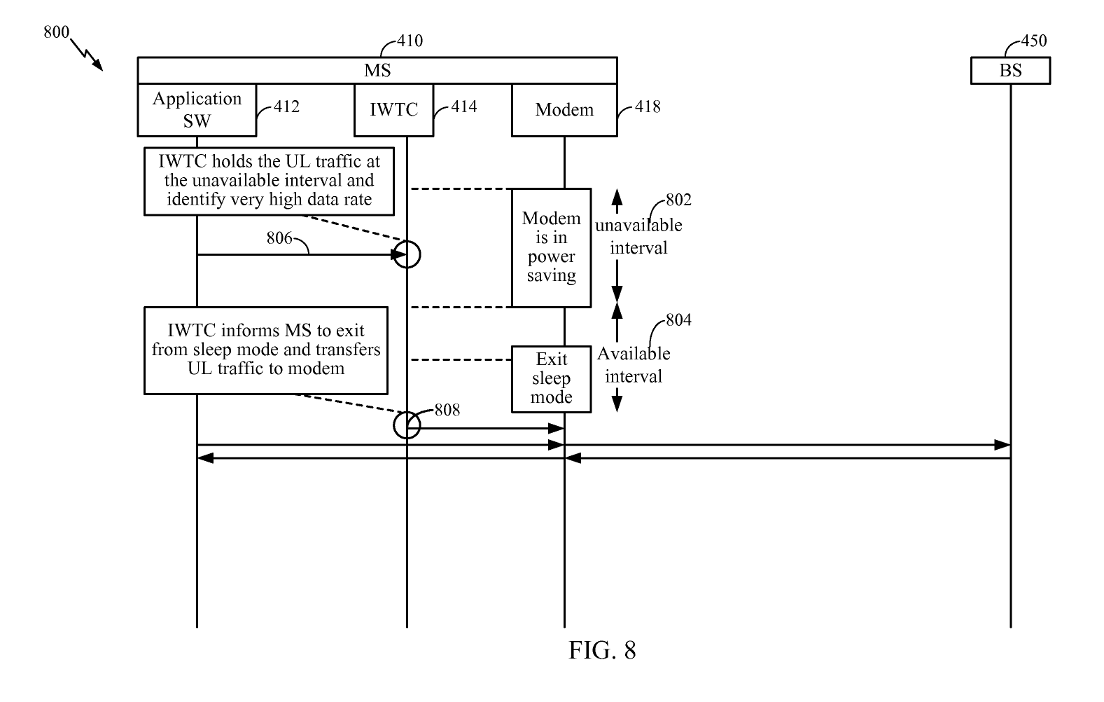

FIG. 8 illustrates an example call flow diagram 800 where the IWTC 414 extends power savings, according to aspects of the present disclosure. At 806, the IWTC 414 buffers uplink data during an unavailable interval 802 of a power saving mode. The IWTC 414 may identify that the uplink data rate is above a second threshold that keeps the MS 410 busy transmitting and receiving. This second threshold may correspond to a relatively high data rate.

At 808, the IWTC 414 may inform the modem 418 to exit from the sleep mode and may transfer buffered uplink data to the modem after the modem exits the power saving sleep mode.

As illustrated in FIG. 8, upon identifying that the uplink data rate is above a threshold, for example a threshold corresponding to a relatively high data rate, the IWTC 414 continues to buffer uplink data during the unavailable interval 802. By continuing to buffer uplink data despite the higher uplink data rate, the IWTC 414 increases power saving by extending the sleep mode duration before the modem 418 transits back to a normal operation mode.

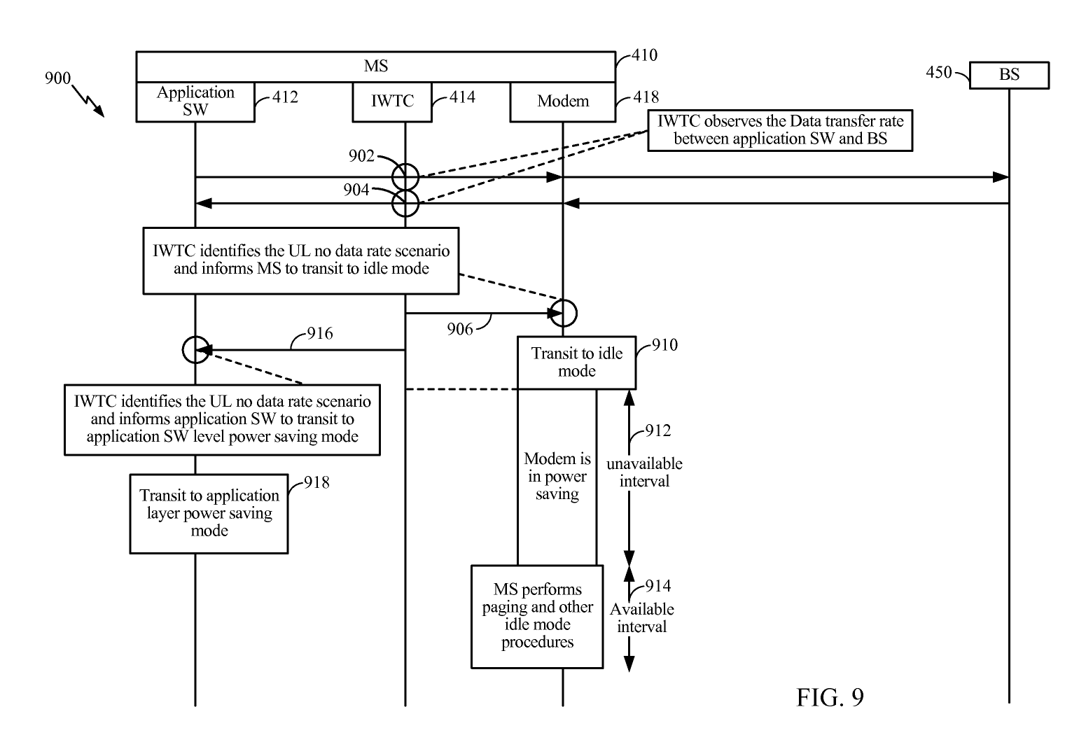

FIG. 9 illustrates an example call flow diagram 900 where the IWTC 414 synchronizes power savings between the application subsystem 412 and the modem 418 of MS 410, according to aspects of the present disclosure.

At 902 and 904, the IWTC 414 observes uplink and downlink data, respectively to determine power savings opportunities. At 906, the IWTC 414 identifies a no uplink data rate scenario and informs the MS 410 to transit to a power saving idle mode. At 916, the IWTC 414 informs the application subsystem 412 to transit to an application level power saving mode. At 910, the modem 418 transits to the idle mode with an unavailable interval 912 and available interval 914. During the available interval 914, the MS 410 may perform paging and other idle mode procedures. At 918, the application subsystem 412 transits to an application layer power saving mode.

According to certain standards, power savings opportunities are focused on the modem level, and not the application subsystem level. However, to achieve increased power saving, both the modem and the application subsystem related hardware should synchronize power saving when needed. Thus, as illustrated in FIG. 9, the IWTC 414 provides a mechanism for synchronizing power savings between the application subsystem 412 and the modem 418 to increase power saving.

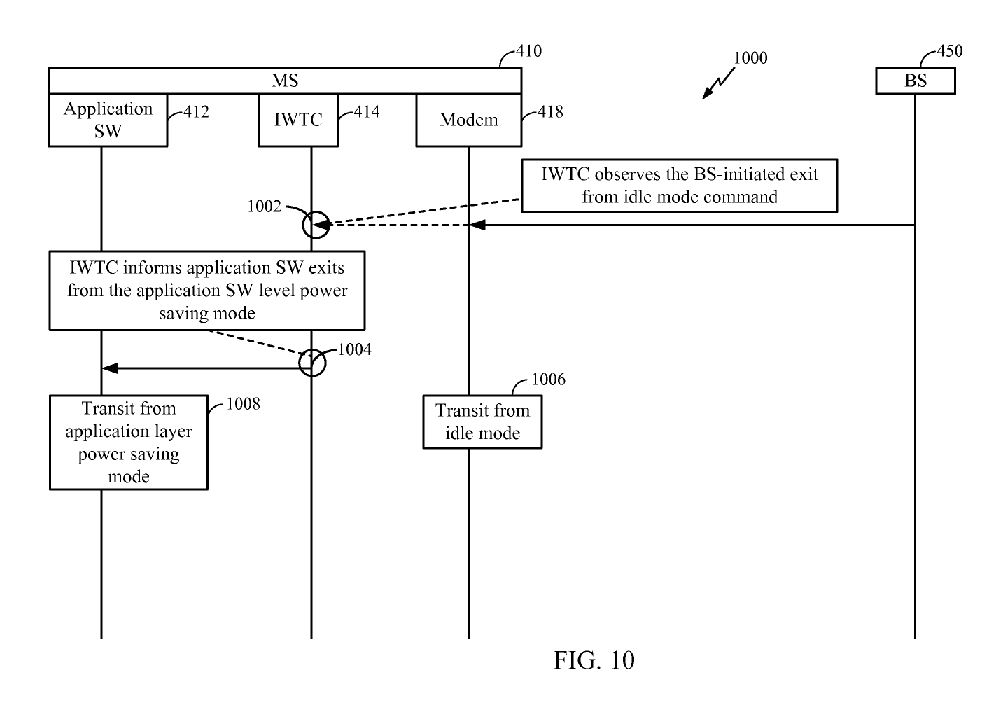

FIG. 10 illustrates an example call flow diagram 1000 where the IWTC 414 informs the application subsystem 412 and modem 418 to exit from a power saving mode, in accordance with aspects of the present disclosure.

In FIG. 10, the application subsystem 412 is initially in a power saving mode and the modem 418 is initially in an idle mode. At 1002, the IWTC 414 observes a BS-initiated exit from idle mode command. At 1004, the IWTC 414 may direct the application subsystem 412, including its software and hardware components, to exit from the power saving mode. At 1006 and 1008, the modem 418 transits from the idle mode and the application subsystem 412 transits from the power saving mode. With assistance from the IWTC 414, an application processor of the application subsystem 412 may adjust a processor clock rate from low to high to meet a required Millions of Instructions per Second (MIPS) for a regular data rate scenario.

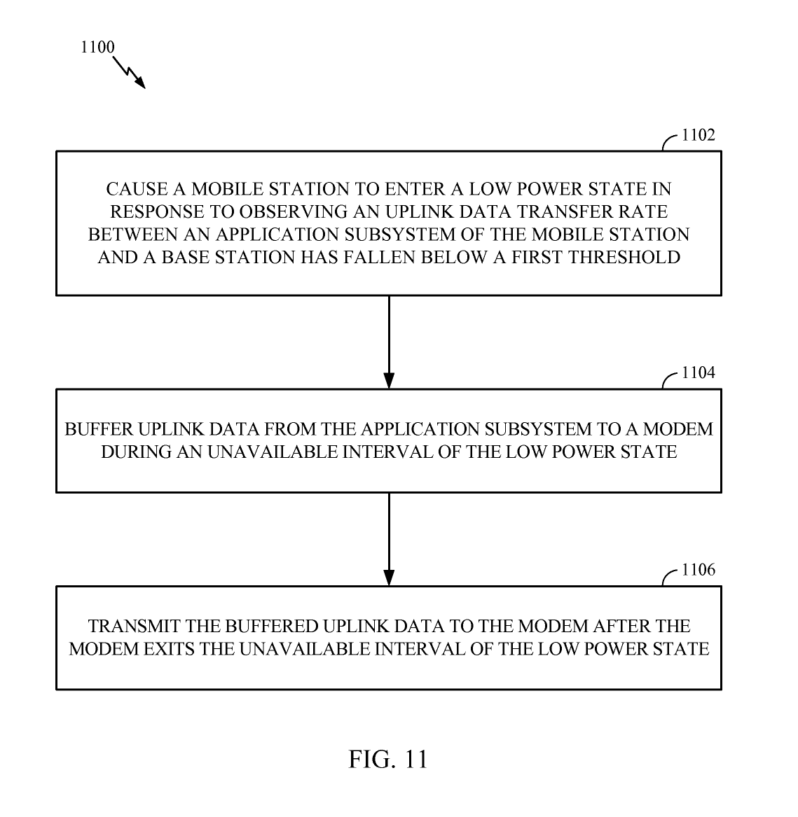

FIG. 11 illustrates example operations 1100, which may be performed, for example, at a mobile station by a software module, in accordance with aspects of the present disclosure.

At 1102, the software module may cause a MS to enter a low power state in response to observing an uplink data transfer rate between an application subsystem of the mobile station and a base station has fallen below a first threshold. At 1104, the software module may buffer uplink data from the application subsystem to a modem during an unavailable interval of the low power state. At 1106, the software module may transmit the buffered uplink data to the modem after the modem exits the unavailable interval of the low power state.

As described above, aspects of the present disclosure provide methods to increase power savings at a MS based on uplink and downlink connections and the current data rate. According to aspects, a software module which may reside between an application subsystem and a modem of the MS may buffer uplink data during power saving intervals to allow the MS to remain in a sleep mode unavailable interval during a low data rate scenario and to remain in a sleep mode available interval during a burst data rate scenario. According to aspects, the software module may increase power savings by focusing not only on power saving at the modem, but also on power saving at an application subsystem.

### Determine Sleep Window Size Based on Traffic Conditions and QoS Parameters

WiMAX 16e allows a MS to negotiate with a BS for a period of absent time even during an active traffic connection. During this time, the MS may not communicate with the BS. Thus, the MS may turn off unnecessary components in an effort to save power. The BS may allocate bandwidth to other MSs in the network that may otherwise be allocated to the absent MS. The absent time may be called a sleep window or an unavailable interval.

The MS is said to be in a power saving mode, or sleep mode when the negotiation for a sleep window is successful. The MS becomes available to communicate with the BS in between sleep windows. The available period is called a listening window. A sleep cycle consists of one sleep window and one listening window. A MS goes through sleep cycles as long as sleep mode is activated.

Although WiMAX describes the mechanism to activate and deactivate sleep mode, it does not describe the conditions in which sleep mode activation is appropriate or the length of the sleep and listening windows.

Aspects of the present disclosure provide methods to determine a sleep mode opportunity and the duration of the sleep and listening windows based on the QoS parameters negotiated and real-time traffic patterns. The traffic and QoS based method allows for early identification of sleep opportunities, better prediction of entry and exit conditions of the sleep mode, and better reaction to traffic conditions. These advantages ultimately translate into a more efficient use of air link resources and higher power efficiency.

Discussions on sleep triggers may be typically based on traffic inactivity time. However, traffic inactivity time may not be an effective solution for power saving in a low traffic condition where an inactivity timer may not expire. In addition, traffic inactivity time methods may not provide an estimate of the length of the sleep window.

Furthermore, discussions on sleep window size tend towards defining a configurable parameter that may be adjusted manually during field testing. Although this may be a viable solution, the adjustment may be difficult and may not be adapted to different traffic and channel conditions. In addition, since the length of a sleep window may affect traffic patterns, fixing the sleep window size to a constant may violate QoS requirements in some situations.

Accordingly, aspects of the present disclosure use mandatory QoS parameters for each service class to identify sleep opportunities and calculate a sleep window.

### WiMAX as a Queuing System

In the most general terms, each WiMAX service flow may be considered as a queuing system. Data packets may arrive at any point in time and may be independent of the previous data packets. This is especially true in low traffic conditions. Based on these assumptions, the incoming data packet arrival process may modeled as a Poisson Process.

With only one scheduler in the system to place the incoming packets onto the air interface, there is only one server in the queuing system. Data packets may be put onto the air interface by a QoS scheduler.

For UGS and ERT-VR service flows, the BS may periodically provide unsolicited UL grants and transmit fixed size packets periodically on the DL. In other words, the scheduler may periodically place a data packet of known size in a more or less deterministic manner onto the air interface.

For other service flows, namely RT-VR and NRT-VR, the BS may provide unsolicited UL bandwidth request polls periodically and may transmit variable size packets periodically on the DL. Moreover, the scheduler may also hold the packet in the queue for sometime while transmitting other high priority packets when capacity becomes limited. In other words, the scheduler may put the RT-VR and NRT-VR packets onto the air interface independent of previous packets, in a more or less random fashion, while preserving an average rate.

Based on these discussions, the UGS and ERT-VR service flows may be modeled as M/D/1 queues while the RT-VR and NRT-VR service flows may be modeled as M/M/1 queues. The following formulae list the mean latency and variance of the M/D/1 and M/M/1 queues.

$$M / D / 1$$

$$T = \frac{2 - ρ}{2 μ ( 1 - ρ )}$$

$${σ}_{T}^{2} = \frac{ρ ( 4 - ρ )}{12 {{μ}^{2} ( 1 - ρ )}^{2}}$$

$$M / M / 1$$

$$T = \frac{1}{μ - λ}$$

$${σ}_{T}^{2} = \frac{1}{{( μ - λ )}^{2}}$$

In the above formulae, T represents the mean latency of the queue and σ_{T}² represents the variance of the latency. μ represents the average service rate and λ represents the average arrival rate. Finally,

$$ρ = \frac{λ}{μ}$$

represents the utilization factor, which must be less than 1.

The following paragraphs briefly discuss the mandatory QoS parameters, their role in determining a sleep opportunity, and the effect of a sleep window on the QoS parameters. Relationships between QoS parameters, queuing model, and a sleep opportunity will also be discussed.

### WiMAX QoS Parameters

WiMAX defines the following mandatory (M) and optional (O) QoS parameters for each of the supported service classes:

TABLE 1
QoS parameters for service flow category

| | UGS | ERT-VR | RT-VR | NRT-VR | BE |
|---|---|---|---|---|---|
| Max. Sustained Rate (bps) | O | M | M | M | O |
| Max Traffic Burst (bytes) | | | | | |
| Min Reserved Rate(bps) | M | M | M | M | |
| Max Latency (ms) | M | M | M | | |
| Tolerated Jitter (ms) | M | | | | |

Maximum Sustained Rate is measured at the convergence sub-layer as a data packet enters the WiMAX MAC. This parameter represents an upper bound on the input rate for a service flow. The unit may be in bits/s.

For UGS service class, the Maximum Sustained Rate is equal to the Minimum Reserved Rate. Since this parameter only specifies the maximum traffic rate allowed, it acts as a regulator of incoming traffic. As such, the sleep mode operations may not be affected by this parameter.

Minimum Reserved Rate is measured at the convergence sub-layer as a data packet enters the WiMAX MAC. This parameter represents the traffic rate that the BS and SS must be able to support a service flow. This also implies that BS must allocate sufficient bandwidth to support the service flow. However, this does not imply that real-time data traffic may be transmitting at this rate at all times.

When real-time traffic rate falls below the minimum traffic rate, the allocated bandwidth may be wasted. Thus, a sleep opportunity may exist when real-time data traffic rate falls below the Minimum Reserved Rate. As long as real-time traffic rate is lower than the Minimum Reserved Rate, a sleep opportunity continues to exist. Note that sleep window size may not have an effect on the rate of input traffic rate.

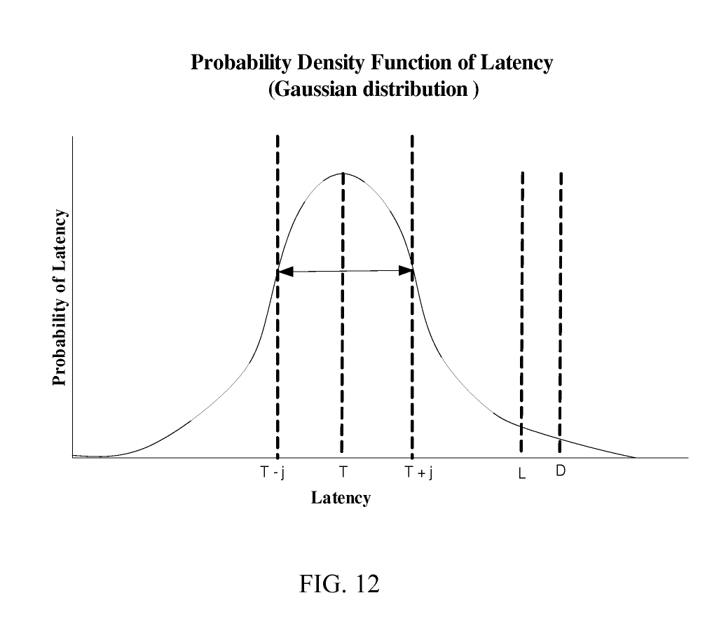

Maximum Latency is a measure of the time between when a data packet enters the convergence sub-layer and is transmitted on the air interface. Maximum Latency may be a statistical measure. For example, a 95-percentile latency figure, illustrated as L in FIG. 12 suggests that 95 percent of the traffic latency must be below the Maximum Latency (D). This latency figure must be respected when estimating sleep window, i.e. L≦D. Mathematically, L may be calculated by solving the following equation:

$$1 - {\int }_{- ∞}^{L} f ( τ ) d τ = c$$

In the above equation, f (τ) represents the probability density function (pdf) of the latency and c represents the desired percentile of the latency. Thus satisfying the 95-percentile Maximum Latency QoS means satisfying the following inequality:

$$P ( τ > D ) = 1 - {\int }_{- ∞}^{D} f ( τ ) d τ \leq c$$

The rate of packets being put on the air interface depends on rate and size of bandwidth allocation from the BS. When real-time traffic rate is low, real-time latency of the packets may also be low since packets entering the system may encounter an almost empty queue and may be transmitted almost immediately. This excess between real-time latency and Maximum Latency allowed represents a sleep opportunity.

As sleep window size increases, packets entering the WiMAX system may not be transmitted as often and may encounter an increasingly busy queue. As a result, packet latency may increase. Thus, Maximum Latency may be an important parameter in determining the maximum sleep window size allowed without violating the QoS parameter.

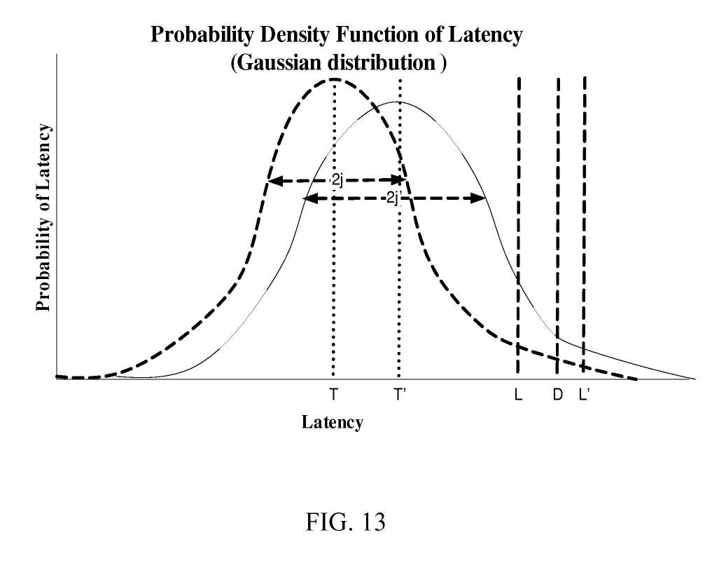

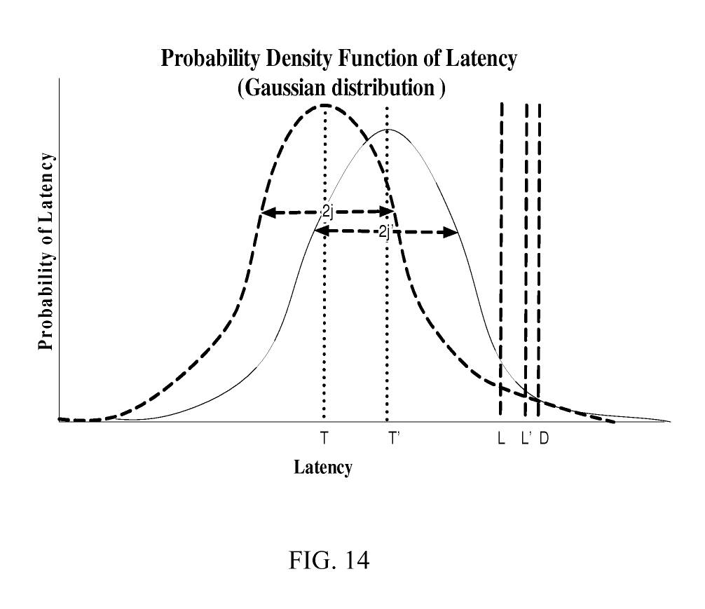

FIGS. 13 and 14 represent the effects of the sleep window on the latency probability density function. In FIG. 13, the sleep window size is increased to a point where the 95-percentile latency (L′) exceeds the Maximum Latency QoS parameter (D). FIG. 14, however, shows that although the sleep window size is increased, the 95-percentile latency (L′) is still within the Maximum Latency (D).

Although FIGS. 13-14 seem to assume a Gaussian Latency probability density function, the probability density function of the latency need not be Gaussian. The important characteristic of the probability density function of the Latency is that: (1) the Mean of the Latency pdf is defined, (2) the Variance of the Latency pdf is defined, and (3) the Tail Probability (the total probability that the latency is greater than D, or P(τ>D)), may be evaluated using only the mean and the variance of the pdf.

When Latency pdf is Gaussian, then:

$$P ( τ > D ) = 1 - {\int }_{- ∞}^{D} f ( τ ) d τ = erf ( \frac{D - T}{{o}_{T}} )$$

According to aspects, erf( ) may be evaluated using a look up table.

Tolerated Jitter is a measure of the degrees of variation of the latency. Tolerated Jitter is, by nature, a statistical measure, as shown in FIG. 12. For example, Tolerated Jitter may be defined such that about 68% of the latency is within Tolerated Range, then tolerated latency range may be defined as T±σ, where σ, defined as the standard deviation of the latency pdf. A 95-percentile Tolerated Jitter is approximately equal to 2σ. Mathematically, Tolerated Jitter may be calculated by solving the following formula:

$$1 - {\int }_{T - j}^{T + j} f ( τ ) d τ = c$$

In the above formula, j represents the Tolerated Jitter, c represents the acceptable delay range in percentage and T represents the mean latency which may be calculated as:

$$T = {\int }_{- ∞}^{∞} τ f ( τ ) d τ$$

When the Tolerated Jitter J is given as a QoS Parameter, then satisfying the Jitter QoS means satisfying the following inequality:

$$P ( \vert τ \vert > J ) = 1 - {\int }_{T - j}^{T + j} f ( τ ) d τ \leq c$$

As the sleep window size increases, jitter may also increase due to the spread in packet latency as a result of the increased sleep window size. FIGS. 13 and 14 illustrate the possible effects on the latency pdf. In FIG. 13, the jitter level, j′, exceeds the Tolerated Jitter. In FIG. 14, the jitter level is still within the range of the Tolerated Jitter.

If Latency is Gaussian, then:

$$P ( \vert τ \vert > J ) = 1 - {\int }_{T - j}^{T + j} f ( τ ) d τ = Q ( \frac{J - T}{{o}_{T}} )$$

According to aspects, Q( ) may be calculated using a look up table.

As described above, a relationship between a WiMAX service flow and queuing theory may be established. Specifically, it was shown that the mean and the variance of the Latency of the queue may be determined as a function of the service rate.

Additionally, a relationship between QoS parameters and sleep opportunities were established. The effects of the sleep window on the Latency pdf and the potential of violating the QoS requirements were discussed. Specifically, it was shown that the sleep window may be determined once the mean, the variance, and the shape of the Latency pdf is defined. Moreover, the defined sleep window may ensure that the various QoS requirements may still be satisfied once the MS enters sleep mode.

The following paragraphs illustrate how the sleep window may be defined when the Latency pdf is assumed to be Gaussian. However, the Latency pdf may be defined by another distribution as long as the tail probabilities, P(τ>D) and P(|τ|>J), may be calculated using the mean, T, and the variance, σ_{T}².

### Sleep Opportunity and Sleep Window for UGS Services

A UGS Service flow may modeled as a M/D/1 queue. The mean and variance of the Latency is given as follows:

$$T = \frac{2 - ρ}{2 μ ( 1 - ρ )}$$

$${σ}_{T}^{2} = \frac{ρ ( 4 - ρ )}{12 {{μ}^{2} ( 1 - ρ )}^{2}}$$

With the mandatory QoS parameters defined, the following procedures may be used to identify a sleep opportunity:

1. Determine the service rate (μ) as given by Minimum Reserved Traffic Rate.

2. Determine the 95-percentile delay (D) as given by Maximum Latency.

3. Determine the 95-percentile jitter (J) as given by Tolerated Jitter.

4. Monitor the incoming traffic rate (λ) at the convergence sub-layer.

5. Monitor the average latency of the packets (T).

6. Calculate the variance of the latency of the packets (σ_{T}²).

7. If all of the following conditions are satisfied, sleep opportunity exist:

$$λ < μ$$

$$T < D$$

$$2 {σ}_{T} < J$$

$$erf ( \frac{D - T}{J / 2} ) \leq 0.05$$

When a sleep opportunity exists, the following procedure may give the appropriate sleep and available window.

1. Find the new service rate μ′:

$${μ}^{′} = \frac{a}{b} μ$$

$$a , b = 1 , 2 , 3 , 4 …$$

In the above formula, a represents the available window and b represents the sleep cycle. A sleep cycle consists of an available window followed by an unavailable window. The size of the window is measured in units of unsolicited grant interval for the UL and grant interval for DL.

2. Verify that the sleep opportunity conditions are still satisfied using the new service rate. Verification may include calculating:

$$λ < {μ}^{′}$$

$${T}^{′} < D$$

$$2 {σ}_{T}^{′} < J$$

$$erf ( \frac{D - {T}^{′}}{J / 2} ) \leq 0.05 , where$$

$${T}^{′} = \frac{2 - {ρ}^{′}}{2 {μ}^{′} ( 1 - {ρ}^{′} )}$$

$$λ < {μ}^{′} , {ρ}^{′} = \frac{λ}{{μ}^{′}}$$

$${σ}_{T}^{′ 2} = \frac{{ρ}^{′} ( 4 - {ρ}^{′} )}{12 {{μ}^{′ 2} ( 1 - {ρ}^{′} )}^{2}}$$

3. Choose a λ′ which maximizes ρ′, either with respect to 1 or some pre-defined non-aero value that is less than 1, while satisfying all of the conditions in step 2.

### Sleep Opportunity and Sleep Window for ERT-VR Service

An ERT-VR Service flow may be modeled as a M/D/1 queue. The mean and variance of the Latency is given as follows:

$$λ < μ$$

$$T < D$$

$$erf ( \frac{D - T}{{σ}_{T}} ) \leq 0.05$$

With the mandatory QoS parameters defined, the following procedures may be used to identify a sleep opportunity.

1. Determine the service rate (μ) as given by Minimum Reserved Traffic Rate.

2. Determine the 95-percentile delay (D) as given by Maximum Latency.

3. Monitor the incoming traffic rate (λ) at the convergence sub-layer.

4. Monitor the average latency of the packets (T).

5. Calculate the variance of the latency of the packets (σ_{T}²).

6. If all of the following conditions are satisfied, sleep opportunity exist.

$${μ}^{′} = \frac{a}{b} μ$$

$$a , b = 1 , 2 , 3 , 4 …$$

When a sleep opportunity exists, the following procedures may give the appropriate sleep and available window.

1. Find the new service rate μ′:

$${μ}^{′} = \frac{a}{b} μ$$

$$a , b = 1 , 2 , 3 , 4 …$$

In the above formula, a represents the available window and b represents the sleep cycle. A sleep cycle consists of an available window followed by an unavailable window. The size of the window is measured in units of unsolicited grant interval for the UL and grant interval for DL.

2. Verify that the sleep opportunity conditions are still satisfied using the new service rate. Verification may include calculating:

$$λ < {μ}^{′}$$

$${T}^{′} < D$$

$$erf ( \frac{D - {T}^{′}}{{σ}_{T}^{′}} ) \leq 0.05 , \\ where$$

$${T}^{′} = \frac{2 - {ρ}^{′}}{2 {μ}^{′} ( 1 - {ρ}^{′} )}$$

$$λ < {μ}^{′} , {ρ}^{′} = \frac{λ}{{μ}^{′}}$$

$${σ}_{T}^{′ 2} = \frac{{ρ}^{′} ( 4 - {ρ}^{′} )}{12 {{μ}^{′ 2} ( 1 - {ρ}^{′} )}^{2}}$$

3. Choose a μ′ which maximizes ρ′, either with respect to 1 or some pre-defined non-aero value that is less than 1, while satisfying all of the conditions in step 2.

### Sleep Opportunity and Sleep Window for RT-VR Service

A RT-VR Service flow may be modeled as a M/M/1 queue. The mean and variance of the Latency may be given as follows:

$$T = \frac{1}{μ - λ}$$

$${σ}_{T}^{2} = \frac{1}{{( μ - λ )}^{2}}$$

With the mandatory QoS parameters defined, the following procedure may be used to identify a sleep opportunity.

1. Determine the service rate (μ) as given by Minimum Reserved Traffic Rate.

2. Determine the 95-percentile delay (D) as given by Maximum Latency.

3. Monitor the incoming traffic rate (λ) at the convergence sub-layer.

4. Monitor the average latency of the packets (T).

5. Calculate the variance of the latency of the packets (σ_{T}²).

6. If all of the following conditions are satisfied, sleep opportunity exist.

$$λ < μ$$

$$T < D$$

$$erf ( \frac{D - T}{{σ}_{T}} ) \leq 0.05$$

When a sleep opportunity exists, the following procedures may give the appropriate sleep and available window.

1. Find the new service rate μ′:

$${μ}^{′} = \frac{a}{b} μ$$

$$a , b = 1 , 2 , 3 , 4 …$$

In the above formula, a represents the available window and b represents the sleep cycle. A sleep cycle consists of an available window followed by an unavailable window. The size of the window is measured in units of unsolicited grant interval for the UL and grant interval for DL.

2. Verify that the sleep opportunity conditions are still satisfied using the new service rate. Verification may include calculating:

$$λ < {μ}^{′}$$

$${T}^{′} < D$$

$$erf ( \frac{D - {T}^{′}}{{σ}_{T}^{′}} ) \leq 0.05 , \\ where$$

$${T}^{′} = \frac{1}{{μ}^{′} - λ}$$

$$λ < {μ}^{′} , {ρ}^{′} = \frac{λ}{{μ}^{′}}$$

$${σ}_{T}^{′ 2} = \frac{1}{{( {μ}^{′} - λ )}^{2}}$$

3. Choose a μ′ which maximizes ρ′, either with respect to 1 or some pre-defined non-aero value that is less than 1, while satisfying all the conditions in step 2.

### Sleep Opportunity and Sleep Window for NRT-VR Service

An NRT-VR Service flow may be modeled as a M/M/1 queue. The mean and variance of the Latency is given as follows:

$$T = \frac{1}{μ - λ}$$

$${σ}_{T}^{2} = \frac{1}{{( μ - λ )}^{2}}$$

With the mandatory QoS parameters defined, the following procedures may be used to identify a sleep opportunity.

1. Determine the service rate (μ) as given by Minimum Reserved Traffic Rate.

2. Monitor the incoming traffic rate (λ) at the convergence sub-layer.

3. If the following condition is satisfied, sleep opportunity exist.

λ<μ

When a sleep opportunity exists, the following procedures give the appropriate sleep and available window.

1. Find the new service rate μ′:

$${μ}^{′} = \frac{a}{b} μ$$

$$a , b = 1 , 2 , 3 , 4 …$$

In the above formula, a represents the available window and b represents the sleep cycle. A sleep cycle consists of an available window followed by an unavailable window. The size of the window is measured in units of unsolicited grant interval for the UL and grant interval for DL.

2. Verify that the sleep opportunity conditions are still satisfied using the new service rate. Verification may include calculating:

$$λ < {μ}^{′} , \\ where$$

$$λ < {μ}^{′} , \\ {ρ}^{′} = \frac{λ}{{μ}^{′}}$$

3. Choose a μ′ which maximizes ρ′, either with respect to 1 or some pre-defined non-aero value that is less than 1, while satisfying all of the conditions in step 2.

### Sleep Opportunity and Sleep Window for be Service

BE services do not have associated mandatory QoS parameters. As a result, sleep opportunities may not be identified using QoS Parameters.

### General Sleep Mode Operation

The following steps describe application of the sleep window estimation in the context of sleep mode as defined in WiMAX. The procedures describe the sleep mode operation in a typical WiMAX MS system.

1. An active service flow is created with specific QoS Parameters defined.

2. The statistics of incoming packet rate (λ), the packet latency (T) and the packet latency variance (σ_{T}²) are monitored for each service flow when applicable.

3. After a large enough number of samples of the above statistics are collected, the sleep opportunity and size of sleep window are determined using the aforementioned procedures, specific for each service flow.

4. For service flows that are groups under that same Power Saving Class (PSC), the smallest sleep window size among all the service flow may be used as the sleep window for the group.

5. If a sleep window for any PSC is non-zero, the MS may send a SLP-REQ that defines and activates the corresponding PSC.

6. Once a SLP-RSP is received confirming the activation of the PSC, the MS enters sleep mode.

7. MS continues to collect running statistics of the parameters mentioned in Step 1. If QoS requirements of any service flow within the PSC may be violated, the PSC may be deactivated and Sleep mode is exited.

8. After sleep mode is exited, the MS continues to collect running statistics of the parameters mentioned in Step 1. Step 1 to Step 7 may be repeated as long as there are active service flows in a PSC.

According to aspects of the present disclosure, a WiMAX service flow may be modeled as M/D/1 or M/M/1 queue. This implies the service rate may be modeled as a deterministic process or a Poisson process, respectively. According to aspects, the service rate may be better modeled by another random process. In this case, the M/G/1 queue may apply.

The main result from queuing theory using a M/G/1 queue to model a WiMAX service flow is the P-K transformation formulae. These formulae relate the number of packets in the queue, the latency, and the waiting time of the queuing system to the service time process without defining the service time process. The following formulae show the P-K transformation formulae for the latency.

P-K Transformation Formula

$${L}^{*} ( s ) = {S}^{*} ( s ) \frac{s ( 1 - ρ )}{s - λ + λ {S}^{*} ( s )} = 𝓁 ( f ( τ ) )$$

$${S}^{*} ( s ) = 𝓁 ( s ( t ) )$$

Mean and Variance

$$E ( f ( τ ) ) = T = - \frac{d}{d s} {L}^{*} ( s ) {\vert}_{s = 0} \\ E ( {f}^{2} ( τ ) ) = \frac{{d}^{2}}{d {s}^{2}} {L}^{*} ( s ) {\vert}_{s = 0} \\ Var ( f ( τ ) ) = {σ}_{T}^{2} = E ( {f}^{2} ( τ ) ) - {( E ( f ( τ ) ) )}^{2}$$

In the above formula, L*(s) represents the Laplace transform of the latency pdf, f(τ), S*(s) represents the Laplace transform of the service time pdf, s(t),

$$ρ = \frac{λ}{μ}$$

represents the utilization factor, λ, represents the Poisson arrival rate and μ represents the mean service rate.

The P-K transformation formula of Latency illustrates that once the service rate process is defined, the mean and the variance of the Latency process may be readily available. In fact, the result of M/M/1 and M/D/1 queue may be obtained by substituting S*(s) by the respective Laplace transform of the Poisson and deterministic process, namely:

M/M/1

$${S}^{*} ( s ) = \frac{μ}{s + μ}$$

M/D/1

$${S}^{*} ( s ) = {e}^{- \frac{s}{μ}}$$

Aspects of the present disclosure illustrate that WiMAX service flows may be modeled as a queue system with Poisson arrival process. In the most general case, the M/G/1 queue model may be used. In this case the sleep window and the available window can be determined using the following steps.

1. Define the service time process, s(t) and derive S*(s).

2. Using S*(s) derive an expression for T and σ_{T}² using the P-K transformation formulae.

3. Define the mean service rate, μ, based on QoS parameter set for the service flow.

4. Define the maximum delay, D, based on QoS parameter set for the service flow, when applicable.

5. Define the maximum jitter, J, based on the QoS parameter set for the service flow.

6. Define the model for the Latency process and provides a way to calculate P(τ>X) and P(|τ|>Y) in terms of the mean and the variance of the latency process.

7. Monitor the arrival rate λ, the mean latency, T, and the variance of the latency, σ_{T}², of the real-time system.

8. Declare that the sleep opportunity exists when:
T<D, when condition is applicable
P(τ>D)≦c, when condition is applicable
P(|τ|>J)≦c, when condition is applicable

9. If sleep opportunity exits, derive a new service rate μ′:

$${μ}^{′} = \frac{a}{b} μ$$

$$a , b = 1 , 2 , 3 , 4 …$$

Recalculate the mean and variance of the latency, T′ and σ_{T}² using the corresponding expressions derived in step 2. μ′ must be chosen such that:

λ<μ′
T′<D, when condition is applicable
P(τ>D)≦c, when condition is applicable
P(|τ|>J)≦J, when condition is applicable
λ/μ is maximized either with respect to 1 or some pre-defined non-aero value that is less than 1

10. When μ′ is determined, a represents the listening window and b represents the sleep cycle. Thus, sleep window is b-a. a and b may be measured in units of grant or polling interval of the service flow.

11. Continue to monitor the statistics after sleep mode is entered. If any of the conditions in step 8 are violated, exit sleep mode.

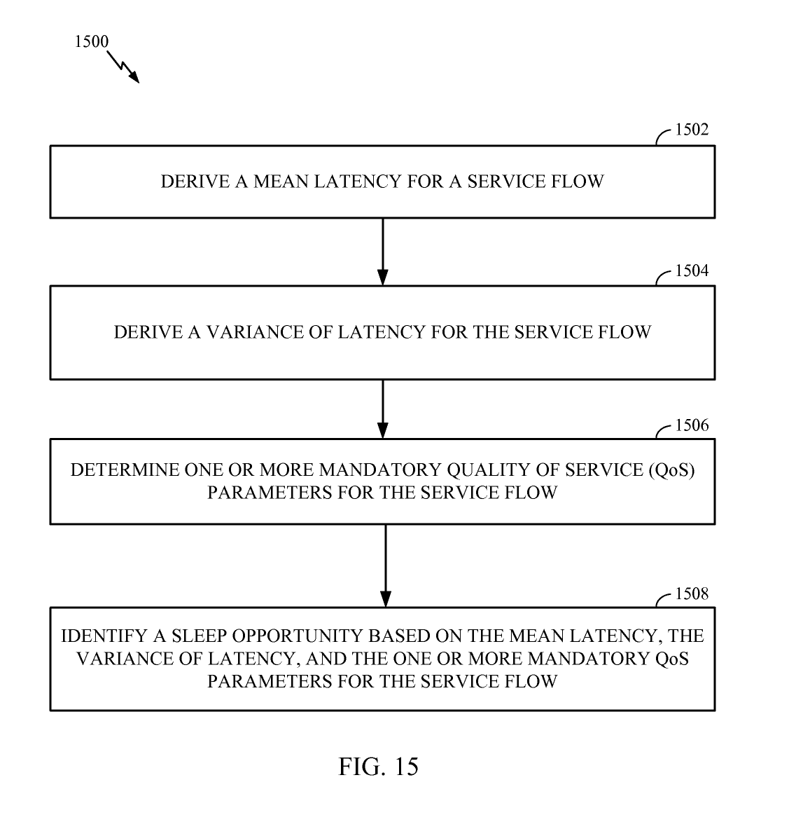

FIG. 15 illustrates example operations 1500 that may be performed, for example by a device in a wireless communications system, in accordance with aspects of the present disclosure. At 1502, a mean latency for a service flow may be derived. At 1504, a variance of latency for the service flow may be derived. At 1506, one or more mandatory quality of service (QoS) parameters for the service flow may be determined. At 1508, a sleep opportunity may be identified based on the mean latency, the variance of latency, and the one or more mandatory QoS parameters for the service flow.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The various operations of methods described above may be performed by various hardware and/or software component(s) and/or module(s) corresponding to means-plus-function blocks illustrated in the Figures. More generally, where there are methods illustrated in Figures having corresponding counterpart means-plus-function Figures, the operation blocks correspond to means-plus-function blocks with similar numbering.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication, comprising:
causing a mobile station to enter a low power state in response to observing an uplink data transfer rate between an application subsystem of the mobile station and a base station has fallen below a first threshold;
buffering uplink data from the application subsystem to a modem during an unavailable interval of the low power state; and
transmitting the buffered uplink data to the modem after the modem exits the unavailable interval of the low power state.

2. The method of claim 1, wherein causing the mobile station to enter the low power state comprises:
causing the modem to enter a sleep mode.

3. The method of claim 2, wherein transmitting the buffered uplink data to the modem comprises:
transmitting the buffered uplink data during an available interval of the sleep mode.

4. The method of claim 2, wherein transmitting the buffered uplink data to the modem comprises:
transmitting the buffered uplink data after the modem exits the low power state in response to the uplink data transfer rate exceeding a second threshold.

5. The method of claim 4, further comprising:
adjusting one or more intervals associated with the sleep mode.

6. The method of claim 1, wherein causing the mobile station to enter the low power state comprises:
synchronizing power saving at the application subsystem and the modem of the mobile station.

7. The method of claim 6, wherein synchronizing power saving comprises:
causing the application subsystem and the modem of the mobile station to enter the low power state when no uplink data exists.

8. The method of claim 7, wherein causing the modem to enter the low power state comprises:
causing the modem to enter an idle mode.

9. The method of claim 7, further comprising:
observing a base station-initiated exit from the low power state; and
directing the application subsystem of the mobile station to exit from the low power state.

10. The method of claim 1, wherein causing the mobile station to enter the low power state comprises:
determining a state of one or more applications of the application subsystem; and
altering a quality of service (QoS) of one or more connections maintained by the modem based, at least in part, on the determined state.

11. An apparatus for wireless communication, comprising:
means for causing a mobile station to enter a low power state in response to observing an uplink data transfer rate between an application subsystem of the mobile station and a base station has fallen below a first threshold;
means for buffering uplink data from the application subsystem to a modem during an unavailable interval of the low power state; and
means for transmitting the buffered uplink data to the modem after the modem exits the unavailable interval of the low power state.

12. The apparatus of claim 11, wherein the means for causing the mobile station to enter the low power state comprises:
means for causing the modem to enter a sleep mode.

13. The apparatus of claim 12, wherein the means for transmitting the buffered uplink data to the modem comprises:
means for transmitting the buffered uplink data during an available interval of the sleep mode.

14. The apparatus of claim 12, wherein the means for transmitting the buffered uplink data to the modem comprises:
means for transmitting the buffered uplink data after the modem exits the low power state in response to the uplink data transfer rate exceeding a second threshold.

15. The apparatus of claim 14, further comprising:
means for adjusting one or more intervals associated with the sleep mode.

16. The apparatus of claim 11, wherein the means for causing the mobile station to enter the low power state comprises:
means for synchronizing power saving at the application subsystem and the modem of the mobile station.

17. The apparatus of claim 16, wherein the means for synchronizing power saving comprises:
means for causing the application subsystem and the modem of the mobile station to enter the low power state when no uplink data exists.

18. The apparatus of claim 17, wherein the means for causing the modem to enter the low power state comprises:
means for causing the modem to enter an idle mode.

19. The apparatus of claim 17, further comprising:
means for observing a base station-initiated exit from the low power state; and
means for directing the application subsystem of the mobile station to exit from the low power state.

20. The apparatus of claim 11, wherein causing the mobile station to enter the low power state comprises:
means for determining a state of one or more applications of the application subsystem; and
means for altering a quality of service (QoS) of one or more connections maintained by the modem based, at least in part, on the determined state.

21. An apparatus for wireless communication, comprising:
at least one processor configured to:
cause a mobile station to enter a low power state in response to observing an uplink data transfer rate between an application subsystem of the mobile station and a base station has fallen below a first threshold;
buffer uplink data from the application subsystem to a modem during an unavailable interval of the low power state; and
transmit the buffered uplink data to the modem after the modem exits the unavailable interval of the low power state; and
a memory coupled to the at least one processor.

22. The apparatus of claim 21, wherein the at least one processor is configured to cause the mobile station to enter the low power state by:
causing the modem to enter a sleep mode.

23. The apparatus of claim 22, wherein the at least one processor is configured to transmit the buffered uplink data to the modem by:
transmitting the buffered uplink data during an available interval of the sleep mode.

24. The apparatus of claim 22, wherein the at least one processor is configured to transmit the buffered uplink data to the modem by:
transmitting the buffered uplink data after the modem exits the low power state in response to the uplink data transfer rate exceeding a second threshold.

25. The apparatus of claim 24, wherein the at least one processor is further configured to:
adjust one or more intervals associated with the sleep mode.

26. The apparatus of claim 21, wherein the at least one processor is configured to cause the mobile station to enter the low power state by:
synchronizing power saving at the application subsystem and the modem of the mobile station.

27. The apparatus of claim 26, wherein the at least one processor is configured to synchronize power saving by:
causing the application subsystem and the modem of the mobile station to enter the low power state when no uplink data exists.

28. The apparatus of claim 27, wherein the at least one processor is configured to cause the modem to enter the low power state by:
causing the modem to enter an idle mode.

29. The apparatus of claim 27, wherein the at least one processor is further configured to:
observe a base station-initiated exit from the low power state; and
direct the application subsystem of the mobile station to exit from the low power state.

30. The apparatus of claim 21, wherein the at least one processor is configured to cause the mobile station to enter the low power state by:
determining a state of one or more applications of the application subsystem; and
altering a quality of service (QoS) of one or more connections maintained by the modem based, at least in part, on the determined state.

31. A computer-program product for wireless communication, the computer-program product comprising a non-transitory computer-readable medium having code stored thereon, the code executable by one or more processors for:
causing a mobile station to enter a low power state in response to observing an uplink data transfer rate between an application subsystem of the mobile station and a base station has fallen below a first threshold;
buffering uplink data from the application subsystem to a modem during an unavailable interval of the low power state; and
transmitting the buffered uplink data to the modem after the modem exits the unavailable interval of the low power state.

32. The computer-program product of claim 31, wherein the code for causing the mobile station to enter the low power state comprises:
code for causing the modem to enter a sleep mode.

33. The computer-program product of claim 32, wherein the code for transmitting the buffered uplink data to the modem comprises:
code for transmitting the buffered uplink data during an available interval of the sleep mode.

34. The computer-program product of claim 32, wherein the code for transmitting the buffered uplink data to the modem comprises:
code for transmitting the buffered uplink data after the modem exits the low power state in response to the uplink data transfer rate exceeding a second threshold.

35. The computer-program product of claim 34, further comprising:
code for adjusting one or more intervals associated with the sleep mode.

36. The computer-program product of claim 31, wherein the code for causing the mobile station to enter the low power state comprises:
code for synchronizing power saving at the application subsystem and the modem of the mobile station.

37. The computer-program product of claim 36, wherein the code for synchronizing power saving comprises:
code for causing the application subsystem and the modem of the mobile station to enter the low power state when no uplink data exists.

38. The computer-program product of claim 37, wherein the code for causing the modem to enter the low power state comprises:
code for causing the modem to enter an idle mode.

39. The computer-program product of claim 37, further comprising:
code for observing a base station-initiated exit from the low power state; and
code for directing the application subsystem of the mobile station to exit from the low power state.

40. The computer-program product of claim 31, wherein the code for causing the mobile station to enter the low power state comprises:
code for determining a state of one or more applications of the application subsystem; and
code for altering a quality of service (QoS) of one or more connections maintained by the modem based, at least in part, on the determined state.

41. A method for wireless communication, comprising:
deriving a mean latency for a service flow;
deriving a variance of latency for the service flow;
determining one or more mandatory quality of service (QoS) parameters for the service flow; and
identifying a sleep opportunity based on the mean latency, the variance of latency, and the one or more mandatory QoS parameters for the service flow.

42. The method of claim 41, further comprising:
mapping the service flow to a queuing model.

43. The method of claim 41, further comprising:
determining an unavailable interval and an available interval based on the identified sleep opportunity.

44. The method of claim 41, further comprising:
determining an average service rate for the sleep opportunity.

45. The method of claim 44, wherein the average service rate is based on an available interval and an unavailable interval.

46. The method of claim 44, further comprising:
verifying the average service rate for the sleep opportunity satisfies sleep opportunity conditions.

47. The method of claim 44, wherein the average service rate maximizes a utilization factor.

48. An apparatus for wireless communication, comprising:
means for deriving a mean latency for a service flow;
means for deriving a variance of latency for the service flow;
means for determining one or more mandatory quality of service (QoS) parameters for the service flow; and
means for identifying a sleep opportunity based on the mean latency, the variance of latency, and the one or more mandatory QoS parameters for the service flow.

49. The apparatus of claim 48, further comprising:
means for mapping the service flow to a queuing model.

50. The apparatus of claim 48, further comprising:
means for determining an unavailable interval and an available interval based on the identified sleep opportunity.

51. The apparatus of claim 48, further comprising:
means for determining an average service rate for the sleep opportunity.

52. The apparatus of claim 51, wherein the average service rate is based on an available interval and an unavailable interval.

53. The apparatus of claim 51, further comprising:
means for verifying the average service rate for the sleep opportunity satisfies sleep opportunity conditions.

54. The apparatus of claim 51, wherein the average service rate maximizes a utilization factor.

55. An apparatus for wireless communication, comprising:
at least one processor configured to:
derive a mean latency for a service flow;
derive a variance of latency for the service flow;
determine one or more mandatory quality of service (QoS) parameters for the service flow; and
identify a sleep opportunity based on the mean latency, the variance of latency, and the one or more mandatory QoS parameters for the service flow; and
a memory coupled to the at least one processor.

56. The apparatus of claim 55, wherein the at least one processor is further configured to:
map the service flow to a queuing model.

57. The apparatus of claim 55, wherein the at least one processor is further configured to:
determine an unavailable interval and an available interval based on the identified sleep opportunity.

58. The apparatus of claim 55, wherein the at least one processor is further configured to:
determine an average service rate for the sleep opportunity.

59. The apparatus of claim 58, wherein the average service rate is based on an available interval and an unavailable interval.

60. The apparatus of claim 58, wherein the at least one processor is further configured to:
verify the average service rate for the sleep opportunity satisfies sleep opportunity conditions.

61. The apparatus of claim 58, wherein the average service rate maximizes a utilization factor.

62. A computer-program product for wireless communication, the computer-program product comprising a non-transitory computer-readable medium having code stored thereon, the code executable by one or more processors for:
deriving a mean latency for a service flow;
deriving a variance of latency for the service flow;
determining one or more mandatory quality of service (QoS) parameters for the service flow; and
identifying a sleep opportunity based on the mean latency, the variance of latency, and the one or more mandatory QoS parameters for the service flow.

63. The computer-program product of claim 62, further comprising:
code for mapping the service flow to a queuing model.

64. The computer-program product of claim 62, further comprising:
code for determining an unavailable interval and an available interval based on the identified sleep opportunity.

65. The computer-program product of claim 62, further comprising:
code for determining an average service rate for the sleep opportunity.

66. The computer-program product of claim 65, wherein the average service rate is based on an available interval and an unavailable interval.

67. The computer-program product of claim 65, further comprising:
code for verifying the average service rate for the sleep opportunity satisfies sleep opportunity conditions.

68. The computer-program product of claim 65, wherein the average service rate maximizes a utilization factor.
